(19) United States
(12) Patent Application Publication
(10) Pub. No.: US 2021/0020347 A1
(43) Pub. Date: Jan. 21, 2021

(54) INDUCTOR WITH CORE HAVING COOLING FEATURES

(71) Applicant: Ford Giobal Technologies, LLC, Dearborn, MI (US)

(72) Inventors: Chuanbing Rong, Canton, MI (US); Srikanthan Sridharan, Dearborn, MI (US)

(21) Appl. No.: 16/516,880

(22) Filed: Jul. 19, 2019

(51) Int. Cl. H01F 27/22; H01F 17/04; H01F 27/30

(52) U.S. Cl. CPC H01F 27/22; H01F 27/306; H01F 17/04

(57) ABSTRACT

An inductor includes a magnetic core having opposing first and second plates spaced apart from each other and a plurality of cooling pillars extending from the first plate to the second plate. The pillars are positioned such that a network of channels is formed between the plates and the pillars. A conductor is arranged in a plurality of coils, Each of the coils are supported by one of the pillars such that the coils are disposed between the first and second plates to be cooled by the channels.

### TECHNICAL FIELD

This disclosure relates to inductors and more specifically to thermal management of inductors.

### BACKGOUND

Electric vehicles may include a voltage converter (e.g., a DC-DC converter) connected between the battery and the electric machine. Electric vehicles that have AC electric machines also include an inverter connected between the DC-DC converter and each electric machine. A voltage converter increases (“boosts”) or decreases (“bucks”) the voltage potential to facilitate torque capability optimization. The DC-DC converter includes an inductor (or reactor), switches and diodes. A typical inductor includes a conductive coil that is wound around a magnetic core. The inductor generates heat as current flows through the coil and core.

### SUMMARY

According to on embodiment, an inductor includes a magnetic core having opposing first and second plates spaced apart from each other and a plurality of cooling pillars extending from the first plate to the second plate. The pillars are positioned such that a network of channels is formed between the plates and the pillars. A conductor is arranged in a plurality of coils. Each of the coils are supported by one of the pillars such that the coils are disposed between the first and second plates to be cooled by the channels.

According to another embodiment, an inductor assembly includes a magnetic core and a conductor. The magnetic core includes a body having at least one inner side defining an opening and a plurality of fins projecting outwardly from the body such that gaps are defined between the fins. The body and the fins are formed of a common material. The conductor is wrapped around the body such that a portion of the conductor is disposed in the gaps.

According to yet another embodiment, an inductor assembly includes a magnetic core having a base, a plurality of cooling pillars extending from the base such that the pillars are spaced apart from each other, and a top supported on the pillars. A conductor is wrapped around each of the pillars such that at least a portion of the conductor is exposed to an airflow channel defined between the pillars.

### BRIEF DESCRIPTION OF THE DRAWN

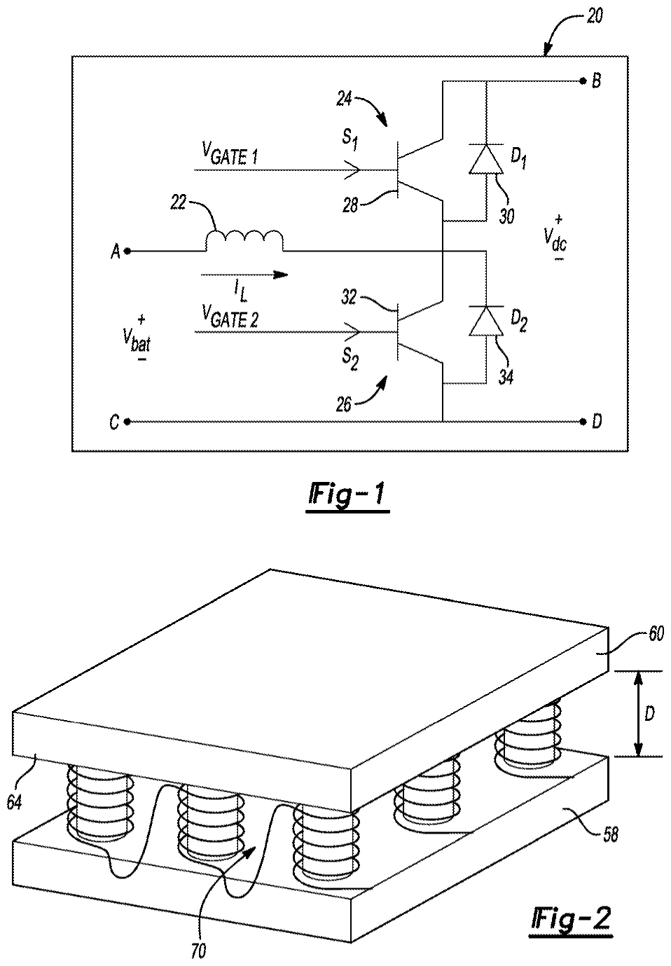

FIG. 1 is a circuit diagram of a variable-voltage converter.

FIG. 2 is perspective view of an inductor according to one or more embodiments.

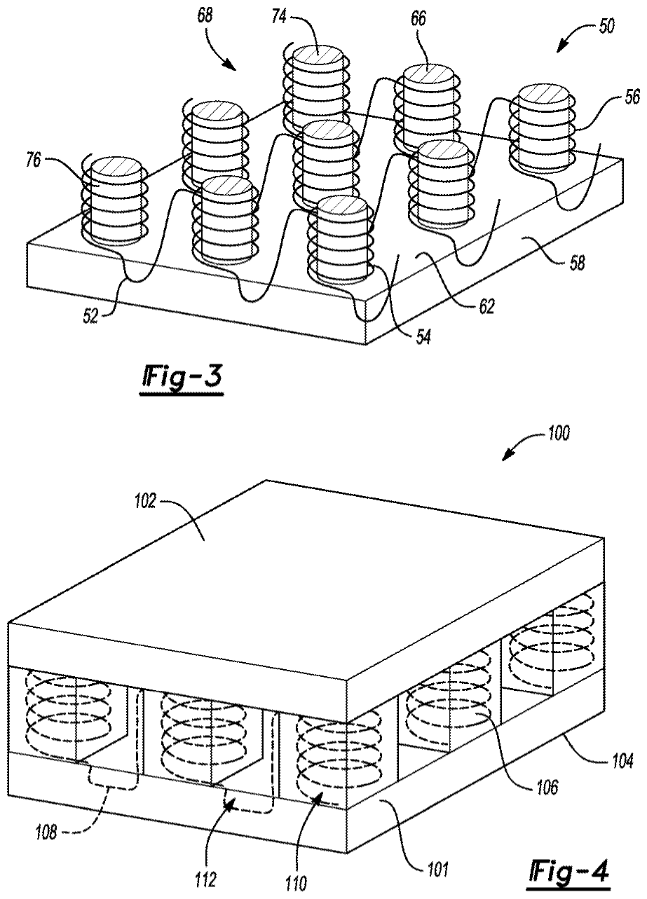

FIG. 3 is a perspective view of the inductor of FIG. 2 with the top plate removed for illustrative purposes.

FIG. 4 is a perspective view of an inductor according to another embodiment.

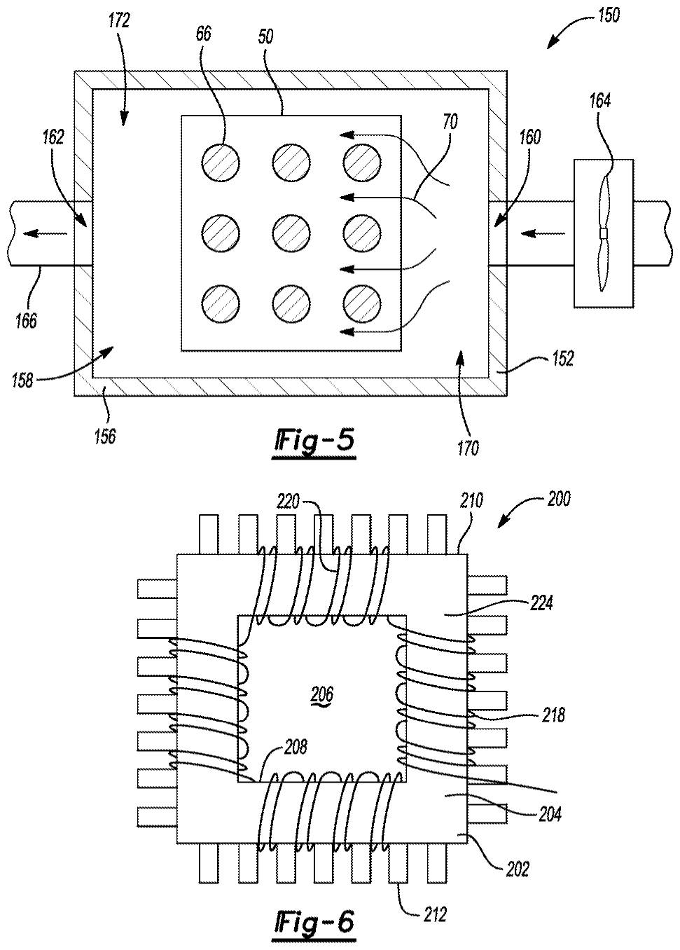

FIG. 5 is a top view, in cross section, of an air-cooled inductor assembly.

FIG. 6 is a front view of an inductor according to yet another embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Vehicles may include an electric powertrain that includes at least one traction motor for powering driven wheels. The traction motor may be powered by a traction battery. The battery is a high-voltage battery capable of outputting. electrical. power to operate the motor. The battery also receives electrical power from the motor when operating as a generators. A high-voltage bus electrically connects the battery to the motor. The vehicle may include one or more controllers for operating various components. The vehicle controllers generally include any number of microprocessors, ASICs, ICs, memory (e.g., FLASH, ROM, RAM, EPROM and/or EEPROM) and software code to co-act with one another to perform a series of operations. The controllers also include predetermined data, or “look-up tables” that are based on calculations and test data and stored within the memory. The controllers communicate with other vehicle systems and each other over one or more wired or wireless vehicle connections using common bus protocols (e.g., CAN and LIN).

The vehicle may include a DC-DC converter or variable voltage converter (VVC) and an inverter. The VVC and the inverter are electrically connected between the battery and the motor. The VVC 10 may “boost” or increases the voltage potential of the electrical power provided by the battery and may “buck” or decreases the voltage potential of the electrical power provided to the battery. The inverter inverts the DC power supplied by the battery (through the VVC 10) to AC power for operating the motor. The inverter also rectifies AC to DC.

Referring to FIG. 1, a VVC 20 includes an inductor 22. The VVC 20 also includes a number of switches and diodes. For example, the VVC 20 includes a first switching unit 24 and a second switching unit 26 for boosting the input voltage (V_{bat}) to provide output voltage (V_{dc}). The first switching unit 24 includes a first transistor 28 connected in parallel to a first diode 30, but with their polarities switched (anti-parallel). The second switching unit 26 includes a second transistor 32 connected anti-parallel to a second diode 34. Each transistor 28, 32 may be any type of controllable switch (e.g., an insulated gate bipolar transistor (IGBT) or field-effect transistor (FET)). Additionally each transistor 28, 32 is individually controlled by a controller. The inductor 22 is depicted as an input inductor connected in series between the battery and the switching units 24, 26. The inductor 22 generates magnetic when current is supplied. When the current flowing through the inductor 22 changes, a time-varying magnetic field is created, and voltage is induced. The VVC 20 may also include different circuit configurations (e.g., more than two switches).

The following Figures and related text describe example inductors according to one or more aspects of this disclosure.

Referring to FIGS. 2 and 3, an inductor 50 includes a core 52 and one or more conductors 54. The inductor 50 is designed to be at least air-cooled. The core 52 is formed of a magnetic material such as ferromagnetic metal, ferrimagnetic compounds, and the like. The core 52 may have a high magnetic permeability and is used to confine and guide magnetic fields. The high permeability of the core 52, relative to the surrounding air, causes the magnetic-field lines to be concentrated in the core 52. The magnetic field is created by current in the conductor 54 that are wrapped around portions of the core 52. The conductor 54 is formed of a conductive material, such as copper or aluminum wire, and has coils 56 that are wound onto portions of the core 52. The conductor 54 may be flat or round wire.

In the illustrated embodiment, the core 52 includes opposing first and second plates 58, 60 spaced apart from each other by a distance (D). The plates may be planar and substantially parallel to each. Used herein, “substantially parallel” means within plus-or-minus five degrees of parallel. The plates 58, 60 define inner sides 62 and 64, respectively. The plates 58, 60 may be rectangular as shown or another shape.

The core 52 further includes a plurality of cooling pillars 66 extending from the inner surface 62 of the first plate to the inner surface 64 of the second plate. The pillars 66 may be substantially perpendicular to the plates 58, 60. Used herein, “substantially perpendicular” means within plus-or-minus five degrees of perpendicular. The pillars 66 may be attached to one or more of the plates 58, 60, or may be integrally formed with one of the plates. For example, the pillars 66 may be integrally formed with the plate 58 and subsequently joined to the plate 60 after the conductor 54 is installed. The pillars 66 may be attached by fasteners, welding, bonding, compression, mechanical interlock, and the like. The pillars 66 are arranged in. an array 68 with spacing between the pillars 66. The pillars 66, in cooperation with the plates 58, 60, define a network of channels 70 for cooling the inductor 50. The pillars 66 act as cooling fins that exchange heat with a working fluid (e.g., air) within the channels 70 and conduct magnetic flux since they are a portion of the core 52. The plates 58, 60 and the cooling pillars 66 may be formed of a common, e.g., same, material. The pillars 66 may be cylindrical (as shown) with end faces 74 attached to the plates and cylindrical sidewalls 76 forming outer surfaces of the pillars 66. In other embodiments, the pillars 66 may be prismatic such as a rectangular prism.

Each of the coils 56 is wrapped around one of the cooling pillars 66 with the coils being wound on the sidewall 76. The pillars 66 are dual purpose: they support the coils 56 and act as cooling fins. In some embodiments, all of the coils 56 may be part of the same circuit and connected in series or parallel. Alternatively, the conductor 54 may include multiple inductor circuits. For example, a first set of the coils are connected to each other to form a first inductor circuit, and a second set of the coils are connected to each other to form a second inductor circuit. Placing the coils 56 on the pillars 66 puts the coils 56 at least partially in the flow channels 70 so that they are in direct contact with the cooling medium, e.g., air.

The inductor 50 may be air-cooled passively, or a fan or similar circulation device may generate an airstream that circulates through the airflow channels 70. The airstream absorbs heat from the pillars 66, the plates 58, 60, and the coils 56 as it passes therethrough to thermally regulate the inductor 50. The inductor could also be liquid cooled.

Referring to FIG. 4, the coils may be embedded in the pillars as shown in inductor 100. The inductor 100 may be the same as inductor 50 except for the coils being embedded in the core. The inductor 100 includes a core 101 having opposing plates (102 and 104) and pillars 106. The pillars 106 may be rectangular (as shown) or may be cylinders like the pillars 66. The inductor 100 includes a conductor 108 that is embedded in the core 101. The conductor 108 includes coils 110 embedded within the pillars 106 and other portions 112 disposed in the plate 104 and/or the plate 102. Placing the conductor 108 inside the core 101 may improve the efficiency of the inductor.

FIG. 5 illustrates an inductor assembly 150 that includes an inductor, such. as inductor 50 or 100, a housing 152, and a fan 154 for air-cooling the inductor. (For purposes of description, the assembly 150 will be described as having inductor 50). The housing 152 includes sidewalk 156 that define an interior 158. The inductor 50 is disposed in the interior 158. The housing defines an inlet 160 and an outlet 162. A fan 164 is connected in fluid communication with interior 158 by a conduit or the like. In some embodiments, the fan 164 may be located in the interior 158. An exhaust conduit 166 is connected to the outlet 162 and carries away heated air. During operation, the fan 164 forces air into the interior 158 creating a high-pressure zone 170. Air in the high-pressure zone 170 is routed through the inductor 50 via the channels 70 and exchanges heat with the pillars 66, the plates 58, 60, and the conductor 54 to cool the inductor 50. The airstreams exiting the inductor 50 converge in a low-pressure zone 172 and are subsequently carried away via the exhaust conduit 166. The fan 164 could be located on the exhaust side of the inductor assembly 150 in alternative embodiments.

In other embodiments, the inductor may be liquid cooled. The inductor may be disposed within a cavity configured to circulate a liquid working fluid, such as oil, therethrough so that the liquid working fluid passes by the pillars to exchange heat with the core and the coils. The liquid-cooled inductor assembly includes a circulation device (e.g., a pump) for circulating coolant. Alternatively, the inductor may be disposed on a cold-plate. For example, one of the plates may be supported on a cold plate the circulates liquid coolant therethrough. Here, the inductor is cooled by a combination of the cold plate and heat transfer between the pillars and the air. The heat transfer with the air may be passive or an airstream may be sent through the inductor.

FIG. 6 illustrates yet another inductor 200. The inductor 200 includes a magnetic core 202 having a body 204 with at least one inner side 208 defining an opening 206. The body 204 may be rectangular, circular, ovular, or other closed shape. The illustrated rectangular body 204 includes four inner sides 208 that define the opening 206 and four outer sides 210. The core 202 includes a plurality of cooling fins 212 projecting from the body 204. The fins 212 may extend from the outer sides 210 as shown and/or may extend from the inner sides 208. The body 204 and the fins 212 are formed of a common material. Therefore, the fins 212 are part of the core 202 and aid in providing a lower-resistance (reluctance) path for the field generated by the windings. The body 204 and the fins 212 may be integrally formed. The composition of the core 202 may be as described above.

One or more conductors 218 are wrapped around the core 202. The conductors 218 are wrapped around the body 204 to form one or more coils 220 around the inner sides 208 and the outer sides 210. The coil 220 is warped to be between the fins 212. The coils need not be wrapped around all four sides. For example, the conductor may include two coils wrapped around opposing sides. The inductor 200 may include one or more inductor circuits as described above.

The inductor 200 may be passively air-cooled or an associated fan may provide an airstream through the inductor. The fins 212 (as well as the body) are configured to exchange heat with the air to cool the inductor 200. The inductor 200 may be part of an inductor assembly similar to that of FIG. 5. The inductor 200 may be oriented in a housing with a front side 224 generally perpendicular to the airstream. In other embodiments the fins 212 may project from the front side 224 and/or the back side. The inductor 200 may also be liquid-cooled.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An inductor assembly comprising:
an inductor including:
a magnetic core haying opposing first and second plates spaced apart from each other and a plurality of cooling pillars extending from the first plate to the second plate, the pillars being positioned such that a network of channels is formed between the plates and the pillars; and
a conductor arranged in a plurality of coils, each of the coils being supported by one of the pillars such that the coils are disposed between the first and second plates to be cooled by the channels.

2. The inductor assembly of claim 1, wherein each of the coils is wrapped around an exterior of the one of the pillars.

3. The inductor assembly of claim 1, wherein the pillars have a cylindrical shape.

4. The inductor assembly of claim 1, wherein each of the coils is embedded within an interior of the one of the pillars.

5. The inductor assembly of claim 1, wherein the first and second plates and the pillars are formed of a common material.

6. The inductor assembly of claim 1, wherein the first plate and the pillars are integrally formed.

7. The inductor assembly of claim 1 further comprising a circulation device configured to circulate a working fluid through the channels.

8. The inductor assembly of claim 1 further comprising:
a housing defining an interior, wherein the inductor is disposed in the interior; and
a fan in fluid communication with the interior and configured to circulate air through the channels.

9. The inductor assembly of claim 8, wherein the fan is disposed within the interior.

10. The inductor assembly of claim 1, wherein each of the coils is connected in series.

11. The inductor assembly of claim 1, wherein a first set of the coils are connected to each other to form a first inductor circuit, and a second set of the coils are connected to each other to form a second inductor circuit.

12. An inductor assembly comprising:
a magnetic core including a body having at least one inner side defining an opening and a plurality of fins projecting outwardly from the body such that gaps are defined between the fins, wherein the body and the fins are formed of a common material; and
a conductor being wrapped around the body such that a portion of the conductor is disposed in the gaps.

13. The inductor assembly of claim 12, wherein the body and the fins are integrally formed.

14. The inductor assembly of claim 12 further comprising a circulation device configured to circulate a working fluid through the fins.

15. The inductor assembly of claim 12 further comprising:
a housing defining an interior that receives the magnetic core; and
a fan in fluid communication with the interior and configured to circulate air through the fins.

16. An inductor assembly comprising:
a magnetic core including a base, a plurality of cooling pillars extending from the base such that the pillars are spaced apart from each other, and a top supported on the pillars; and
a conductor being wrapped around each of the pillars such that at least a portion of the conductor is exposed to an airflow channel defined between the pillars.

17. The inductor assembly of claim 16, wherein the base, the cooling pillars, and the top are formed of a common material.

18. The inductor assembly of claim 17, wherein the base and the cooling pillars are integrally formed.

19. The inductor assembly of claim 16 further comprising a fan configured to circulate air through the airflow channels.

20. The inductor assembly of claim 16, wherein the pillars have a cylindrical shape.
